(19) United States
(12) Patent Application Publication
(10) Pub. No.: US 2006/0160547 A1
(43) Pub. Date: Jul. 20, 2006

(54) Time calibration method for mobile phone

(75) Inventor: Xiaosi Yang, Shanghai (CN)

Correspondence Address: PERKINS COIE LLP;PATENT-SEA, P.O. BOX 1247, SEATTLE, WA, 98111-1247, US

(73) Assignee: Spreadtrum Communications Corporation, Sunnyvale, CA (US)

(21) Appl. No.: 11/202,830

(22) Filed: Aug. 12, 2005

(30) Foreign Application Priority Data
Jan. 20, 2005 (CN) 200510023468.3

(51) Int. Cl. H04Q 7/20

(52) U.S. Cl. 455/466

(57) ABSTRACT

A simplified time calibration method for a telecommunication device, such as a mobile phone. The method comprises: (a) having the mobile phone send a short message to itself, (b) recording successively the uncalibrated time of sending and receiving the short message; (c) extracting the calibrated time included in the received short message, (d) setting the internal clock of the mobile phone based upon the time data generated.

### TECHNICAL FIELD OF THE INVENTION

The present invention relates to a time calibration method for telecommunication devices, and more particularly, a mobile phone.

### BACKGROUND

Most telecommunications devices, such as mobile phone, continuously display an internally-kept time. When the time deviates from the actual time, the phone user must manually reset the time. It will be appreciated that this method is not only inconvenient, but also may result in inaccuracy.

A time setting apparatus is disclosed in Chinese Patent No. CN2497348Y, which comprises a receiver unit and a circuit for information processing and time display. In the described method, the receiver extracts the time data broadcasted by the GPS system or other network paging signal. Then, a microprocessor adjusts the internal clock in accordance with the extracted time information. Finally, this calibrated time is displayed.

### SUMMARY OF THE INVENTION

The present invention provides a time calibration method for an communication device which can perform the time calibration operation automatically once a user elects to have the time calibration performed.

The time calibration method of the invention comprises: (a) the mobile phone sending itself a specified short message, (b) the mobile phone recording the time of sending of the short message, (c) the mobile phone recording the time of receiving the short message, and (d) the mobile phone extracting the time information included in the received short message. This time information (or time data) is the standard time that the SC (short for SMS center) receives the short message. The time information is then inserted into the to-be-rerouted short message by SC. Finally, the mobile phone corrects the internal clock with the time data calculated by performing mathematic calculation using the values stored at step (b), step (c), and step (d).

It is apparent that one advantage of the time calibration method is the ready and accurate reference time used for time calibration. This method can be widely embodied in various wireless communication systems such as GSM, CDMA and TD-SCDMA standard

### BRIEF DESCRIPTION OF THE DRAWINGS

FIG. 1 is the flow chart illustrating the time calibration method of the present invention.

### DESCRIPTION OF THE PREFERRED EMBODIMENT

The present invention is described in the context of a GSM system, and relates to and utilizes GSM's SMTP (short message transmission protocol). However, it can be appreciated that the present invention may also be used in connection with other types of wireless protocols.

As specified in SMTP (Short Message Transmission Protocol), there is standard time data contained in the short message received by a mobile phone. The time data is noted once the transmitted short message from the mobile phone arrives at the SMS center (SC) and the time data is inserted into the short message by SMS center for transmission to the receiving mobile phone.

Note that there is a distinction between the time as indicated by the mobile phone (referred to as the “uncalibrated time”) and the time as indicated by the SMS center (referred to as the “calibrated time”).

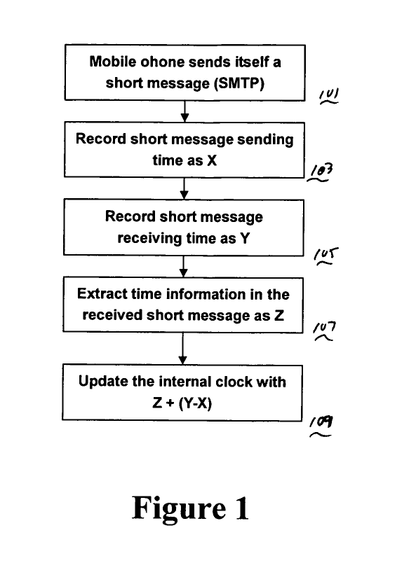

In accordance with the present invention, the time data (the calibrated time) inserted into a short message by the SC can be used to calibrate the clock on a mobile phone. Specifically, according to the present invention as shown in FIG. 1, one embodiment of the present invention comprises:

Step a: The mobile phone sends to itself a specified piece of short message at box 101;

Step b: At box 103, the mobile phone records as “X” the uncalibrated time according to the mobile phone at which the short message is sent at step (a);

Step c: At box 105, the mobile phone records as “Y” the uncalibrated time according to the mobile phone at which the short message is received;

Step d: At box 107, the mobile phone extracts the calibrated time information contained in the received short message as “Z”. Note that Z is the calibrated time that the SC actually received the short message;

Step e: At box 109, the mobile phone updates its internal clock (which maintains the uncalibrated time) to be:
Z+(Y−X)

where X, Y, Z are as defined above and (Y−X) represents the time lag between the sending and receiving of the short message by the mobile phone.

It should be apparent that the present invention represents a significant departure from the prior art. In general, the mobile phone sends a SMS message to itself and uses the SMS center clock to calibrate itself As background, when a mobile phone sends a SMS message, it is sent by a mobile phone to the SMS center. The SMS center will generally receive the SMS message very quickly after the mobile phone has sent the SMS message. The SMS center then will relay the SMS message to the recipient mobile phone. Because SMS messages typically embed the actual (calibrated) time, this information can be used by the recipient mobile phone to calibrate its internal clock.

While particular embodiments of the present invention have been described herein in detail, it is to be understood that various alterations, modifications and substitutions can be made therein without departing in any way from the spirit and scope of the present invention, as defined in the claims which follow. Various modifications and combinations of the illustrative embodiments, as well as other embodiments of the invention, will be apparent to persons skilled in the art upon reference to the description. It is therefore intended that the appended claims encompass any such modifications or embodiments.

1. A method for calibrating the clock of a telecommunications device conforming to and utilizing short message transmission protocol (SMTP), the method comprising the steps of:
(a) having the device send a short message to itself;
(b) noting the uncalibrated time at which the short message was sent by the device at step (a) as X;
(c) noting the uncalibrated time at which the short message is received by the device as Y;
(d) extracting from the short message the calibrated time as Z; and
(e) updating the internal clock based upon the parameters X, Y, and Z.

2. The method of claim 1 wherein said updating of the internal clock is as Z+(Y−X).
